(19) United States
(12) Patent Application Publication
(10) Pub. No.: US 2025/0119825 A1
(43) Pub. Date: Apr. 10, 2025

(54) TECHNIQUES TO DETERMINE UE COMMUNICATION STATES VIA MACHINE LEARNING

(71) Applicant: QUALCOMM Incorporated, San Diego, CA (US)

(72) Inventors: Jie MAO, Beijing (CN); Hong YU, Beijing (CN); Wei LI, Beijing (CN); Nanrun WU, Beijing (CN); Jie ZHU, Beijing (CN); Xinyu WANG, Beijing (CN); Tom CHIN, San Diego, CA (US)

(21) Appl. No.: 18/832,383

(22) PCT Filed: Mar. 29, 2022
(86) PCT No.: PCT/CN2022/083713

§ 371 Date: Jul. 23, 2024

(51) Int. Cl. H04W 48/20; H04B 17/318; H04L 25/02; H04W 24/08; H04W 36/08

(52) U.S. Cl. CPC H04W 48/20; H04B 17/328; H04L 25/0202; H04W 24/08; H04W 36/08

(57) ABSTRACT

Apparatus, methods, and computer-readable media for facilitating determining or predicting a communication state of a UE based on, for example, measurements performed at the UE are disclosed herein. The communication state of the UE, such as an HST state or a non-HST state, may also be associated with a mobility state, such as stationary or moving. The UE may communicate based on the communication state. An example method for wireless communication at a UE includes establishing a connection with a network node. The example method also includes measuring one or more signals received from the network node over a time period. The example method also includes communicating with the network node based on a communication state of the UE, the communication state of the UE based at least in part on a history of measurements performed on the one or more signals received over the time period.

### INTRODUCTION

The present disclosure relates generally to communication systems, and more particularly, to machine learning based techniques for communication state determination.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication at a user equipment (UE) is provided. The method may include establishing a connection with a network node. The example method may also include measuring one or more signals received from the network node over a time period. Additionally, the example method may include communicating with the network node based on a communication state of the UE, the communication state of the UE based at least in part on a history of measurements performed on the one or more signals received over the time period.

In another aspect of the disclosure, an apparatus for wireless communication is provided. The apparatus may be a UE that includes a memory and at least one processor coupled to the memory, the memory and the at least one processor configured to establish a connection with a network node. The memory and the at least one processor may also be configured to measure one or more signals received from the network node over a time period. Additionally, the memory and the at least one processor may be configured to communicate with the network node based on a communication state of the UE, the communication state of the UE based at least in part on a history of measurements performed on the one or more signals received over the time period.

In another aspect of the disclosure, an apparatus for wireless communication at a UE is provided. The apparatus may include means for establishing a connection with a network node. The example apparatus may also include means for measuring one or more signals received from the network node over a time period. The example apparatus may also include means for communicating with the network node based on a communication state of the UE, the communication state of the UE based at least in part on a history of measurements performed on the one or more signals received over the time period.

In another aspect of the disclosure, a non-transitory computer-readable storage medium storing computer executable code for wireless communication at a UE is provided. The code, when executed, may cause a processor to establish a connection with a network node. The example code, when executed, may also cause the processor to measure one or more signals received from the network node over a time period. Additionally, the example code, when executed, may cause the processor to communicate with the network node based on a communication state of the UE, the communication state of the UE based at least in part on a history of measurements performed on the one or more signals received over the time period.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an environment including UEs communicating with different network nodes, in accordance with various aspects of the present disclosure.

FIG. 5 illustrates example measurements of communications in high speed train (HST) cells, in accordance with the teachings disclosed herein.

FIG. 6 is an example communication flow between a base station and a UE, in accordance with the teachings disclosed herein.

FIG. 7 is a diagram of a UE including a neural network configured to determine a communication state of the UE, in accordance with the teachings disclosed herein.

FIG. 8 is a diagram of an example neural network processing technique to determine a communication state of a UE, in accordance with the teachings disclosed herein.

FIG. 9 is a diagram of an example LSTM cell, in accordance with the teachings disclosed herein.

FIG. 10 is a diagram of another example LSTM cell, in accordance with the teachings disclosed herein.

FIG. 11 is a flowchart of a method of wireless communication at a UE, in accordance with the teachings disclosed herein.

FIG. 12 is a flowchart of a method of wireless communication at a UE, in accordance with the teachings disclosed herein.

FIG. 13 is a diagram illustrating an example of a hardware implementation for an example apparatus.

### DETAILED DESCRIPTION

A UE may be located in different communication environments and performance of the UE may be impacted by the respective communication environment. For example, performance of a first UE located in a building may be different than performance of a second UE located in the streets of a downtown area. In another example, performance of a third UE in a relatively high speed environment may be different than a performance of a fourth UE in a relatively stationary environment. Performance of the UE may include communication performance, such as an ability to establish a call or a quality of an established call, may include data transfer performance, such as the speeds and/or reliability associated with transmitting and/or receiving data, etc.

A communication state of a UE may indicate a scenario in which the UE is operating. For example, a UE communication state may indicate that the UE is in a high speed train (HST), may indicate that the UE is in a subway, may indicate that the UE is moving into or moving out of an elevator, etc. The performance of the UE may be impacted based on the UE communication state. For example, high speed environments, such as on an HST, may present difficulties for a UE and wireless communications network to maintain a connection when passing out of a first coverage area of a first base station and into a second coverage area of a second base station. In order to maintain a connection, the UE and the base stations may perform a handover procedure. To ensure that the handover procedure (or a cell re-selection procedure if the UE is in an idle mode) with the base stations is performed in a timely manner, the UE may perform measurements to find new suitable cells. In high speed environments, such measurements may need to be performed relatively frequently.

The UE communication state may additionally, or alternatively, be associated with a mobility state that indicates whether the UE is in a stationary state or a moving state. In some examples, the performance of the UE may be impacted based on the UE mobility state. For example, it may be easier for the UE to maintain a call or communication service when the UE is stationary in an HST than when the UE is moving in an HST.

Aspects disclosed herein facilitate determining or predicting a communication state of a UE based on, for example, measurements performed at the UE. The communication state of the UE may be associated with a scenario in which the UE is operating, such as in an HST (e.g., an “HST state”), outside of or not in an HST (e.g., a “non-HST state”), in an elevator (e.g., an “elevator state”), outside of not in an elevator (e.g., a “non-elevator state”), etc. In some examples, the communication state may also include a mobility state, such as stationary or moving. In some examples, the UE may communicate with a network node based on the communication state. In some examples, the UE may perform or modify a procedure when communicating when communicating with the network node based on the communication station. For example, the UE may perform relatively more frequent measurements when the UE is an HST state than when the UE is in a non-HST state. In additional or alternate examples, the UE may choose which information to measure based on the communication state.

In some examples, the UE may determine the communication state based on a history of measurements performed on signals received over a time period. The measurements may include one or more of a reference signal received power (RSRP), a received signal strength indicator (RSSI), a frequency error, and/or a time advance associated with a Network Time Advance (NTA). In some examples, the measurements may include a rate of PCI change.

In some examples, a cell on which the UE is connected to or camped on may facilitate determining the communication state of the UE. For example, and with respect to high speed environments, the UE communication state may be based on whether the UE is camping on an HST cell or a non-HST cell. In some examples in which the UE is camping on an HST cell, the communication state of the UE may indicate whether the UE is located on an HST (e.g., in an HST state) or not located on an HST (e.g., in a non-HST state). In some examples, the communication state of the UE may be based on a determination of whether the UE is in a moving state or in a stationary state.

As described above, in some examples, the UE may communicate with a network node based on the communication state of the UE. For example, based on the communication state of the UE, the UE may apply different channel estimation algorithms, control channel decoding procedures, and/or signal search procedures. For example, the UE may perform a first type of handover procedure when the UE is camping on an HST cell and not located on an HST, and may perform a second type of handover procedure when the UE is camping on the HST cell and is located on the HST. The second type of handover procedure may be referred to as a “fast handover” and may be associated with signal characteristic measurements performed relatively frequently than when the UE is performing the first type of handover procedure.

Accordingly, aspects presented herein enable a UE to determine a communication state of the UE, which may facilitate improving mobility, for example, by determining a type of procedure to perform based on the communication state and to facilitate communication. The type of procedure may be associated with a signal search procedure, a channel estimation technique, a periodicity of signal characteristic measurements, etc.

Although the following description provides examples directed to determining a communication state of the UE in association with a high speed environment, such as an HST, the concepts described herein may be applicable to other similar areas in which performance of the UE may be impacted based on the communication state or scenario of the UE. For example, a UE connected to or camping on a cell serving an elevator may perform a first type of procedure when in an elevator state and may perform a second type of procedure when in a non-elevator state.

As disclosed herein, the UE may apply a machine learning (ML) algorithm to determine the communication state of the UE. The ML algorithm (sometimes referred to as a “machine learning model”) may use measurements over a time period to determine the communication state of the UE. In some aspects, the ML algorithm may include a long short-term memory (LSTM) architecture to determine the communication state.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

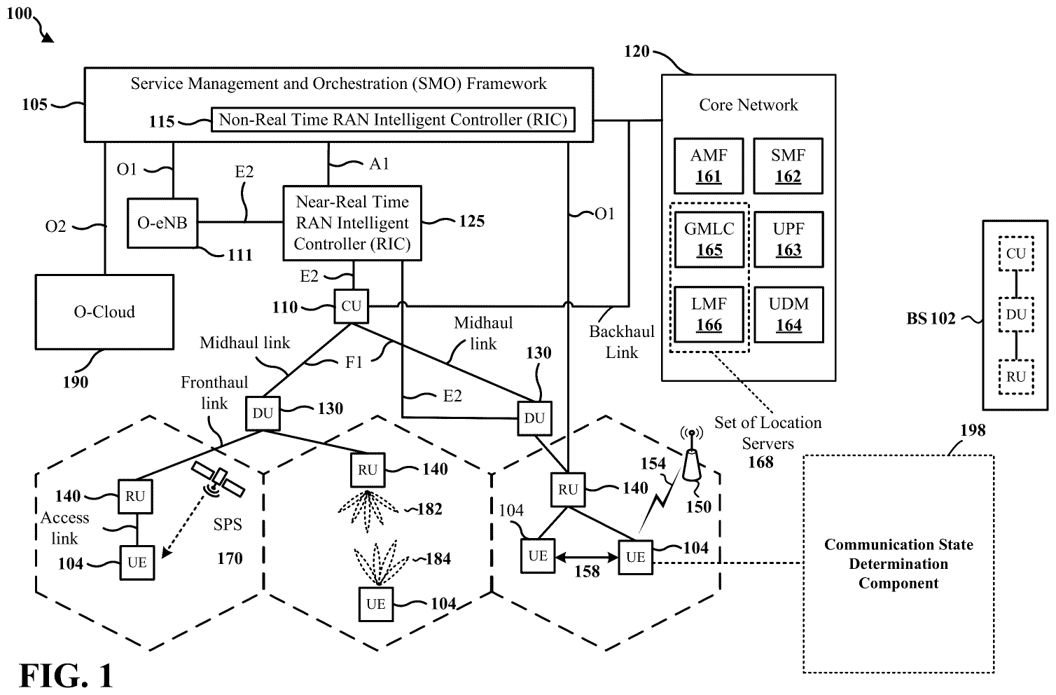

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUS (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., a UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., an RU 140) and the UEs (e.g., a UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between a UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a base station, such as the UE 104 in communication with the base station 102, may be configured to manage one or more aspects of wireless communication. For example, the UE 104 may include a communication state determination component 198 configured to facilitate determining a communication state of the device. In certain aspects, the communication state determination component 198 may be configured to establish a connection with a network node. The example communication state determination component 198 may also be configured to measure one or more signals received from the network node over a time period. Additionally, the example communication state determination component 198 may be configured to communicate with the network node based on a communication state of the UE, the communication state of the UE based at least in part on a history of measurements performed on the one or more signals received over the time period.

The aspects presented herein enable a UE to determine a communication state of the UE, which may facilitate improving mobility, for example, by determining a type of procedure to perform based on the communication state and to facilitate communication. The type of procedure may be associated with a signal search procedure, a channel estimation technique, a periodicity of signal characteristic measurements, etc.

Although the following description provides examples directed to determining a communication state of the UE in association with a high speed environment, such as an HST, the concepts described herein may be applicable to other similar areas in which performance of the UE may be impacted based on the communication state or scenario of the UE. For example, a UE connected to or camping on a cell serving an elevator may perform a first type of procedure when in an elevator state and may perform a second type of procedure when in a non-elevator state.

Additionally, while the following description provides examples directed to 5G NR, the concepts described herein may be applicable to other similar areas, such as LTE, LTE-A, CDMA, GSM, and/or other wireless technologies.

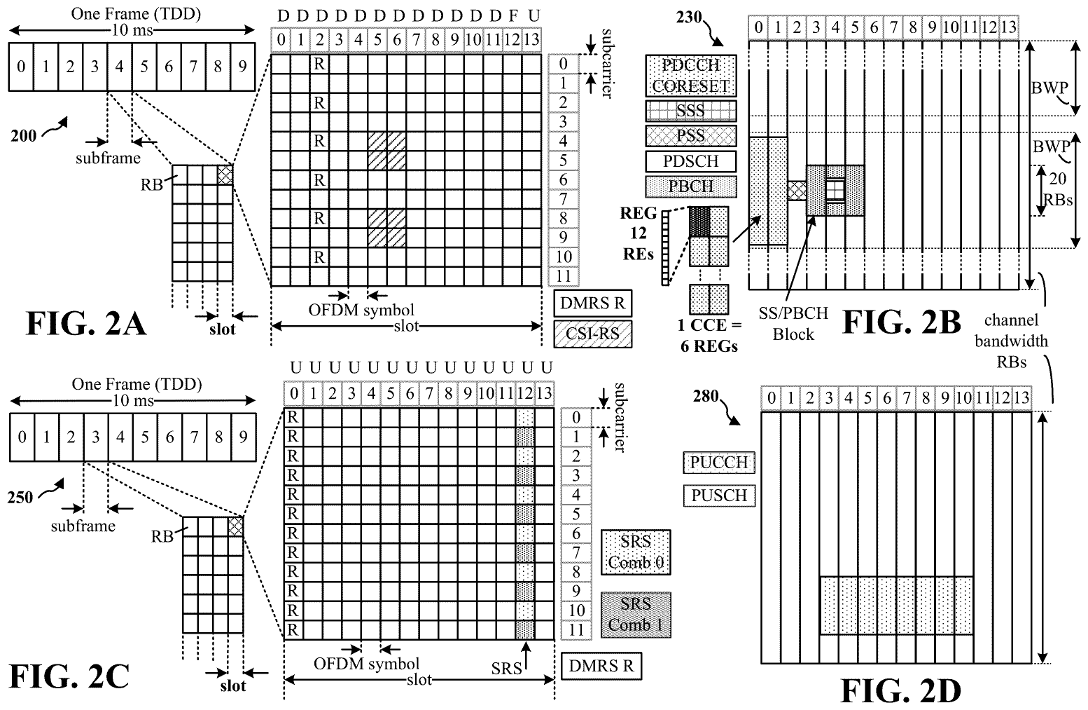

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δƒ = 2^{μ} · 15[kHz] | prefi× |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

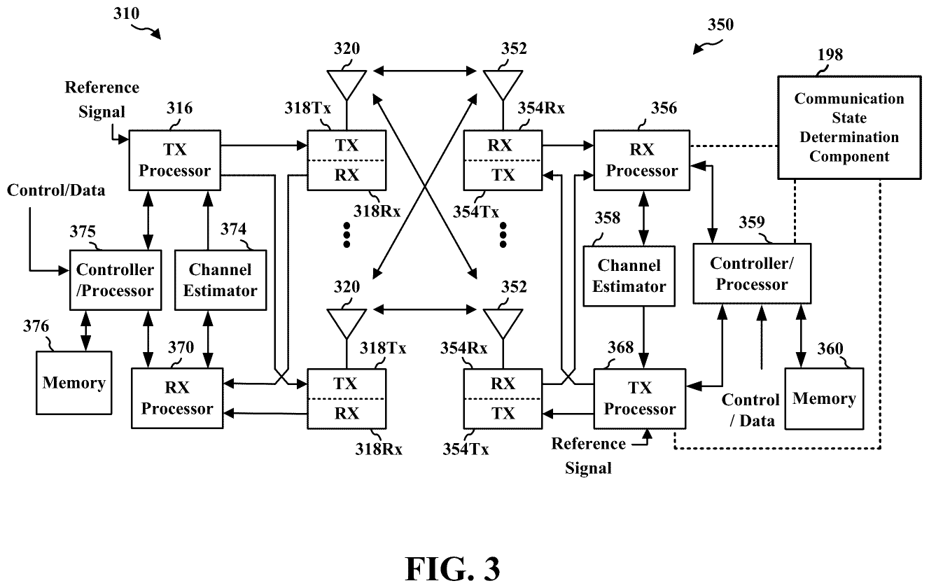

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the communication state determination component 198 of FIG. 1.

A UE may be located in different communication environments and performance of the UE may be impacted by the respective communication environment. For example, performance of a first UE located in a building may be different than performance of a second UE located in the streets of a downtown area. In another example, performance of a third UE in a relatively high speed environment may be different than a performance of a fourth UE in a relatively stationary environment. Performance of the UE may include communication performance, such as an ability to establish a call or a quality of an established call, may include data transfer performance, such as the speeds and/or reliability associated with transmitting and/or receiving data, etc.

A communication state of a UE may indicate a scenario in which the UE is operating. For example, a UE communication state may indicate that the UE is in a high speed train (HST), may indicate that the UE is in a subway, may indicate that the UE is moving into or moving out of an elevator, etc. The performance of the UE may be impacted based on the UE communication state. For example, high speed environments, such as on an HST, may present difficulties for a UE and wireless communications network to maintain a connection when passing out of a first coverage area of a first base station and into a second coverage area of a second base station. In order to maintain a connection, the UE and the base stations may perform a handover procedure. To ensure that the handover procedure (or a cell re-selection procedure if the UE is in an idle mode) with the base stations is performed in a timely manner, the UE may perform measurements to find new suitable cells. In high speed environments, such measurements may need to be performed relatively frequently.

The UE communication state may additionally, or alternatively, be associated with a mobility state that indicates whether the UE is in a stationary state or a moving state. In some examples, the performance of the UE may be impacted based on the UE mobility state. For example, it may be easier for the UE to maintain a call or communication service when the UE is stationary in an HST than when the UE is moving in an HST.

Aspects disclosed herein facilitate determining or predicting a communication state of a UE based on, for example, measurements performed at the UE. The communication state of the UE may be associated with a scenario in which the UE is operating, such as in an HST (e.g., an “HST state”), outside of or not in an HST (e.g., a “non-HST state”), in an elevator (e.g., an “elevator state”), outside of not in an elevator (e.g., a “non-elevator state”), etc. In some examples, the communication state may also include a mobility state, such as stationary or moving. In some examples, the UE may communicate with a network node based on the communication state. In some examples, the UE may perform or modify a procedure when communicating when communicating with the network node based on the communication station. For example, the UE may perform relatively more frequent measurements when the UE is an HST state than when the UE is in a non-HST state.

In some examples, the UE may determine the communication state based on a history of measurements performed on signals received over a time period. The measurements may include one or more of a reference signal received power (RSRP), a received signal strength indicator (RSSI), a frequency error, and/or a time advance associated with a Network Time Advance (NTA). In some examples, the measurements may include a rate of PCI change.

In some examples, a cell on which the UE is connected to or camped on may facilitate determining the communication state of the UE. For example, and with respect to high speed environments, the UE communication state may be based on whether the UE is camping on an HST cell or a non-HST cell. In some examples in which the UE is camping on an HST cell, the communication state of the UE may indicate whether the UE is located on an HST (e.g., in an HST state) or not located on an HST (e.g., in a non-HST state). In some examples, the communication state of the UE may be based on a determination of whether the UE is in a moving state or in a stationary state.

As described above, in some examples, the UE may communicate with a network node based on the communication state of the UE. For example, based on the communication state of the UE, the UE may apply different channel estimation algorithms, control channel decoding procedures, and/or signal search procedures. For example, the UE may perform a first type of handover procedure when the UE is camping on an HST cell and not located on an HST, and may perform a second type of handover procedure when the UE is camping on the HST cell and is located on the HST. The second type of handover procedure may be referred to as a “fast handover” and may be associated with signal characteristic measurements performed relatively frequently than when the UE is performing the first type of handover procedure.

Accordingly, aspects presented herein enable a UE to determine a communication state of the UE, which may facilitate improving mobility, for example, by determining a type of procedure to perform based on the communication state and to facilitate communication. The type of procedure may be associated with a signal search procedure, a channel estimation technique, a periodicity of signal characteristic measurements, etc.

Although the following description provides examples directed to determining a communication state of the UE in association with a high speed environment, such as an HST, the concepts described herein may be applicable to other similar areas in which performance of the UE may be impacted based on the communication state or scenario of the UE. For example, a UE connected to or camping on a cell serving an elevator may perform a first type of procedure when in an elevator state and may perform a second type of procedure when in a non-elevator state.

As disclosed herein, the UE may apply a machine learning (ML) algorithm to determine the communication state of the UE. The ML algorithm may use measurements or metrics to determine the communication state of the UE. For example, the UE may produce time sequence data based on measurements performed on signals over a time period. The measurements may include RSRP, RSSI, frequency error, time advance, PCI change, etc.

In some aspects, the ML algorithm may include an LSTM architecture to determine the communication state. An ML algorithm, such as an artificial neural network (ANN) or a recurrent neural network (RNN), may include an interconnected group of neurons (e.g., neuron models), and may be a computational device or may represent a method to be performed by a computational device. The connections of the neuron models may be modeled as weights. The ML algorithm may provide predictive modeling, adaptive control, and other applications through training via a dataset. The model may be adaptive based on external or internal information that is processed by the ML algorithm. Machine learning may provide non-linear statistical data model or decision making and may model complex relationships between input data and output information.

A neural network, sometimes referred to as an “ML model,” may be trained. For example, a neural network may be trained based on supervised learning or reinforcement learning. During training, the neural network may be provided with input that the neural models use to compute to produce an output. The actual output may be compared to a target output, and the difference may be used to adjust parameters (such as weights and biases) of the neural models in order to provide an output closer to the target output. Before training, the output may be incorrect or less accurate, and an error, or difference, may be calculated between the actual output and the target output. The weights of the neural models may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

As described above, by enabling the UE to determine a communication state of the UE, the UE may communicate with a network node based on the communication state. The communication state may be determined based on a history of measurements performed on one or more signals received over a time period. For example, metrics associated with time sequence data produced by the UE may indicate a pattern that is based on the scenario or the communication state of the UE. As described herein, the UE may apply the history of the measurements to an ML algorithm to determine the communication state. The ML algorithm may employ an LSTM architecture.

In some examples, the output of the ML algorithm may include a categorization of the UE mobility state. For example, the output of the ML algorithm may indicate that the UE is in an HST state or a non-HST state. Thus, in some examples, the UE may apply the history of measurements to one or more instances of the ML algorithm to determine the communication state of the UE. For example, an output of a first instance of the ML algorithm may be associated with a high speed environment, an output of a second instance of the ML algorithm may be associated with an elevator environment, an output of a third instance of the ML algorithm may be associated with a mobility state, etc.

In some examples, the UE may perform the one or more instances of the ML algorithm in sequence. For example, the UE may perform the second instance of the ML algorithm when the output of the first instance of the ML algorithm indicates that the UE is in a non-HST state. In some examples, the UE may perform the one or more instances of the ML algorithm in parallel. For example, the UE may perform one or more instances of the ML algorithm and reconcile the different outputs. For example, in the above example, the output of the first instance may be an HST state, the output of the second instance may be a non-elevator state, and the output of the third instance may be a moving state. Based on the outputs of the first instance, the second instance, and the third instance, the UE may determine that the UE is in an HST state and moving.

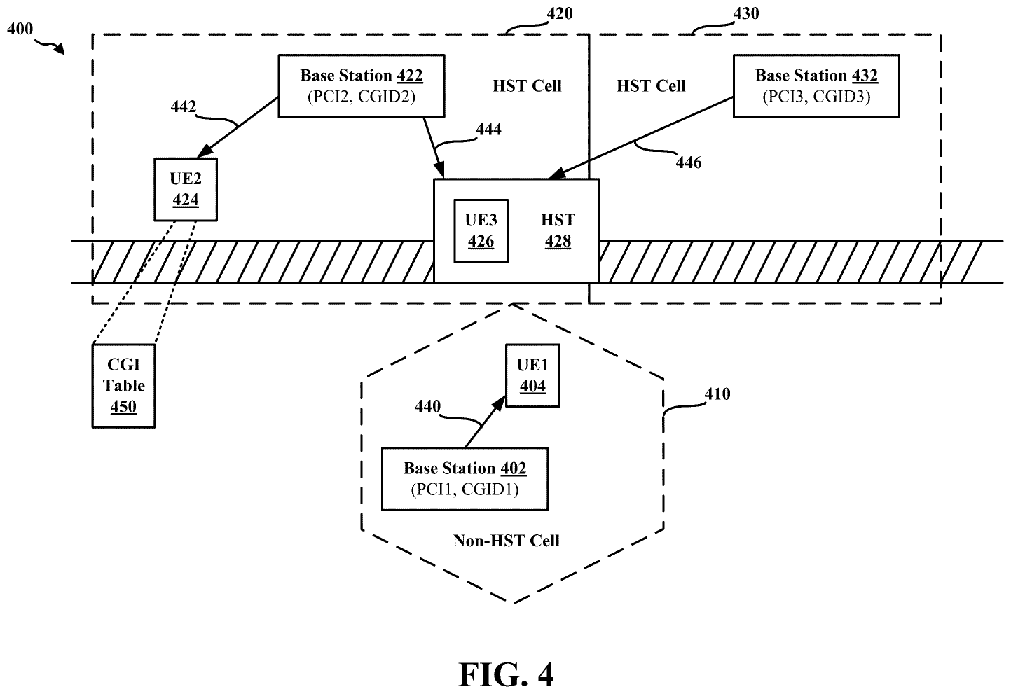

FIG. 4 illustrates an environment 400 including UEs communicating with different network nodes, as presented herein. In the illustrated example of FIG. 4, the environment 400 includes a non-HST cell 410 that is served by a non-HST base station 402, a first HST cell 420 that is served by a first HST base station 422, and a second HST cell 430 that is served by a second HST base station 432. The non-HST cell 410 includes a first UE 404 (“UE1”) that is camping on the non-HST cell 410. As shown in FIG. 4, the first HST cell 420 includes a second UE 424 (“UE2”), a third UE 426 (“UE3”), and an HST 428. In the example of FIG. 4, the second UE 424 is located outside of the HST 428, and the third UE 426 is located in the HST 428. The HST 428 may be in a moving state or in a stationary state. Accordingly, the third UE 426 may be associated with a moving state or a stationary state, for example, based on the state of the HST 428.

In the example of FIG. 4, the first UE 404 is located outside the HST 428, is outside the coverage area of the first HST cell 420, and is not camped on the first HST cell 420. The second UE 424 is located outside the HST 428, is located within the coverage area of the first HST cell 420, and is camped on the first HST cell 420. The third UE 426 is located inside the HST 428, is located within the coverage area of the first HST cell 420, and is camped on the first HST cell 420.

As described above, the communication state (e.g., communication environment or communication scenario) of the UE may impact the performance of the UE. For example, the first UE 404 may apply a signal search procedure, a channel estimation procedure, and/or a control channel decoding procedure that is different than the one applied by the second UE 424 and/or the third UE 426. Additionally, or alternatively, the second UE 424 may apply a signal search procedure, a channel estimation procedure, and/or a control channel decoding procedure that is different than the one applied by the third UE 426. For example, when the HST 428 is in a moving state, the third UE 426 may determine that communications may experience high Doppler effect and, thus, it may be beneficial to apply communication techniques that consider the high Doppler effect. In another example, while the second UE 424 is camping on the first HST cell 420, the second UE 424 may determine that it is moving towards the non-HST cell 410 and, thus, may perform a handover procedure to transition from the first HST cell 420 to the non-HST cell 410. In another example, the third UE 426 may determine that it is moving towards the second HST cell 430 and, thus, may determine to a perform a fast handover procedure to maintain communication when moving from the coverage area of the first HST cell 420 to the coverage area of the second HST cell 430.

Although the non-HST cell 410 is illustrated as having a hexagonal shape and the first HST cell 420 and the second HST cell 430 are illustrated as having a rectangular shape, in other examples, the coverage area associated with the non-HST cell 410, the first HST cell 420, and/or the second HST cell 430 may be associated with a different shape.

In some examples, a UE may determine the communication state of the UE based on upper layer information in signals received from a network node. The upper layer information may include a PCI and/or a Cell Global identifier (CGID). The network nodes may include the upper layer information with their respective output signals. For example, the first UE 404 may receive a first signal set 440 from the non-HST base station 402, the second UE 424 may receive a second signal set 442 from the first HST base station 422, and the third UE 426 may receive a third signal set 444 from the first HST base station 422 and a fourth signal set 446 from the second HST base station 432. Each of the signal sets may include one or more communications over a time period. Signals of the respective signal sets may include the PCI and/or the CGID associated with the respective network node. For example, one or more signals of the first signal set 440 may include the PCI associated with the non-HST base station 402 (“PCI1”), one or more signals of the second signal set 442 and the third signal set 444 may include the PCI associated with the first HST base station 422 (“PCI2”), and one or more signals associated with the fourth signal set 446 may include the PCI associated with the second HST base station 432 (“PCI3”). In a similar manner, one or more signals of the first signal set 440 may include the CGID associated with the non-HST base station 402 (“CGID1”), one or more signals of the second signal set 442 and the third signal set 444 may include the CGID associated with the first HST base station 422 (“CGID2”), and one or more signals associated with the fourth signal set 446 may include the CGID associated with the second HST base station 432 (“CGID3”).

In some examples, the UE may have the ability to determine it is in an HST state based on a rate of PCI change associated with received signals. For example, based on the signals received by the second UE 424 (e.g., the second signal set 442), the second UE 424 may determine it is in a non-HST state since the PCI stays the same. In contrast, if the rate in PCI change between the signals of the third signal set 444 and the fourth signal set 446 is greater than a threshold, then the third UE 426 may determine it is in an HST state. However, in some examples, an HST cell may apply a remote RF header in communications. The remote RF header may include a PCI and may be the same across different HST cells. For example, one or more HST base stations, such as the first HST base station 422 and the second HST base station 432, may include the same PCI in their upper layer information. In such scenarios, the rate of PCI change measured by a UE may not satisfy the threshold to determine that the UE is in an HST state.

In some examples, the UE may be configured with a Cell Global ID (CGI) table including network nodes associated with HST network nodes. For example, the second UE 424 of FIG. 4 includes a CGI table 450 that includes the CGID associated with HST network nodes, such as the first HST base station 422 (“CGID2”) and/or the second HST base station 432 (“CGID3”). Although the example of FIG. 4 illustrates the second UE 424 including the CGI table 450, in other examples, any of the UEs in a wireless communications system may include and/or access a CGI table. In some examples, the UEs may be configured with the CGI table over the air (OTA). In some examples, the UE may determine when it is connected to an HST cell when an identifier of the network node is included in the CGI table. For example, based on the CGID included in the second signal set 442 and the CGI table 450, the second UE 424 may determine it is connected to an HST cell (e.g., the first HST cell 420). However, if the UE is connected to the HST cell and not located on the HST, such as the second UE 424, the UE may incorrectly determine it is in a moving state, for example, based on the moving state of the HST 428.

Thus, the examples using upper layer information (e.g., a PCI, a CGI table, etc.) to determine the communication state of the UE may incorrectly determine the communication state, or the upper layer information may be applicable to a specific scenario. That is, a UE using upper layer information to determine the communication state of the UE may be applicable to a specific scenario and not generally applicable. Additionally, the use of the upper layer information may be unable to exploit the characteristics of the wireless physical channel. For example, metrics associated with signals may exhibit patterns based on the communication state of the UE. Moreover, as the wireless physical channel may change abruptly, for example, when the HST 428 is in the moving state, the UE may be unable to correctly determine the communication state of the UE.

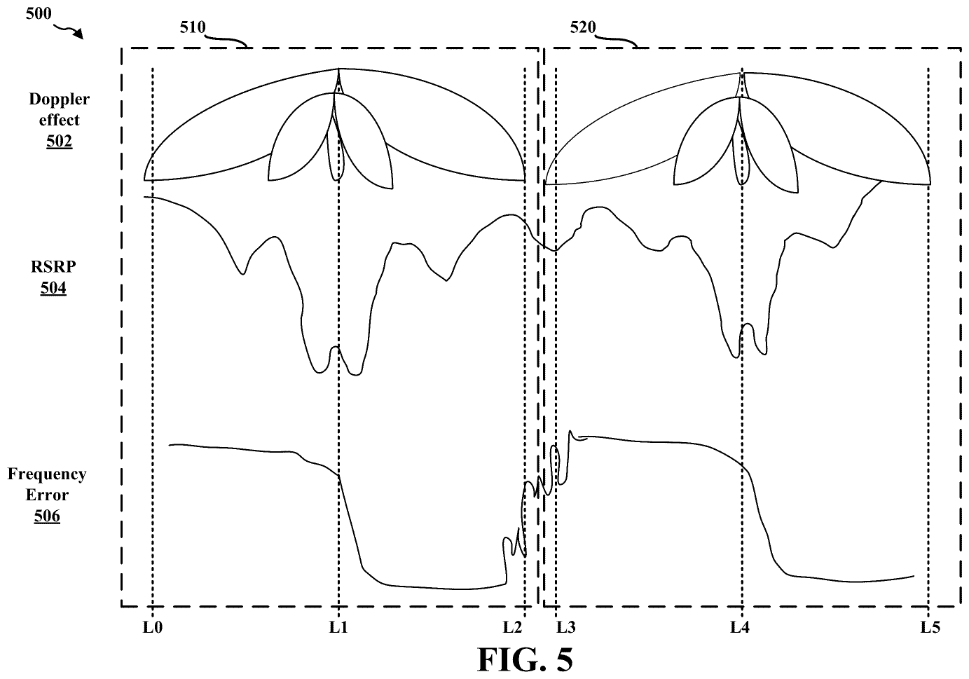

FIG. 5 illustrates example measurements 500 of communications in high speed train (HST) cells, as presented herein. In the illustrated example of FIG. 5, the measurements 500 are performed on communications in a first HST cell 510 and a second HST cell 520. In the example of FIG. 5, the measurements 500 include a Doppler shift 502, an RSRP 504, and a frequency error 506. However, in other examples, the measurements 500 may additionally or alternatively include other metrics, such as an RSSI.

In the example of FIG. 5, a location L1 represents a central location within the first HST cell 510 and a location L4 represents a central location within the second HST cell 520. A location L0 and a location L3 represent a location in a first direction from the location L1 and the location LA within the first HST cell 510 and the second HST cell 520, respectively. A location L2 and a location L5 represent a location in a second direction from the location L1 and the location L4 within the first HST cell 510 and the second HST cell 520, respectively.

In the example of FIG. 5, the measured Doppler shift at the location L0 is a maximum positive Doppler shift, the measured Doppler shift at the location L1 is zero, and the measured Doppler shift at the location L2 is a maximum negative Doppler shift. Similarly, the measured Doppler shift at the location L3 is a maximum positive Doppler shift, the measured Doppler shift at the location L4 is zero, and the measured Doppler shift at the location L5 is a maximum negative Doppler shift. Additionally, the measured RSRP is lowest at the location L1 and the location LA, and increases when moving towards the location L0 or the location L2 within the first HST cell 510, and when moving towards the location L3 or the location L5 within the second HST cell 520. With respect to the frequency error 506, the measured frequency error transitions from a highest measured frequency error at the location L0 and the location L3 of the first HST cell 510 and the second HST cell 520, respectively, to the lowest measured frequency at the location L2 and the location L5 of the first HST cell 510 and the second HST cell 520, respectively.

As shown in FIG. 5, when the UE moves from the first HST cell 510 to the second HST cell 520, the measured Doppler shift at the location L3 jumps from the maximum negative Doppler shift at the location L2 to the maximum positive Doppler shift at the location L3. With respect to the RSRP 504, there is a drop in the measured RSRP between the location L2 of the first HST cell 510 and the location L3 of the second HST cell 520. With respect to the frequency error 506, the measured frequency error jumps from the location L2 of the first HST cell 510 to the location L3 of the second HST cell 520.

As shown in FIG. 5, the measurements 500 are associated with different characteristics based on the location of the UE within the HST cell. Although not shown in the example of FIG. 5, it may be appreciated that measurements of communications in a non-HST cell may be associated with different characteristics. Thus, aspects disclosed may use the characteristics associated with communications to determine the communication state of the UE. For example, the characteristics of measurements performed on communications over a time period may indicate whether the UE is camping on an HST cell or a non-HST cell. The characteristics of measurements performed on communications over the time period may additionally or alternatively indicate whether the UE is in a moving state or in a stationary state. Aspects disclosed here may apply the measurements to an ML model to determine the communication state of the UE. For example, the ML model may use the characteristics associated with the measurements to determine the communication state.

As an example, in an HST state and when the UE is in a moving state, the time advance is usually continuous and a delta is within 50 for a relatively long period. In contrast, in a non-HST state, the time advance changes more often, for example, because the distance from the UE to the base station changes before and after performing a PCI handover procedure. With respect to frequency error, in the HST state, there may be jump gaps due to instantaneous frequency error adjustments for different PCI and the total frequency error may be unable to accommodate for the instantaneous frequency error adjustments. In contrast, in the non-HST state, while there may be jumps due to instantaneous frequency error adjustments, the total frequency error is continuous (e.g., no jump gaps). With respect to RSRP, in the HST state, the RSRP may be less than −70 dBm, for example, because of the likelihood of the UE being close to a base station is low. In contrast, in the HST state, the RSRP may reach −50 dBm, for example, when the UE approaches the base station. It may be appreciated that when the UE is in an HST state and a stationary state, curves associated with the RSRP, the time advance, and the frequency error may be relatively flat as changes in the signal measurements are unlikely while stationary.

Aspects disclosed herein may utilize machine learning techniques to take advantage of the characteristics of the wireless physical channel. Moreover, the machine learning techniques disclosed herein may determine the communication state of the UE with reasonable computation power as the training phase associated with the ML model may be performed offline.

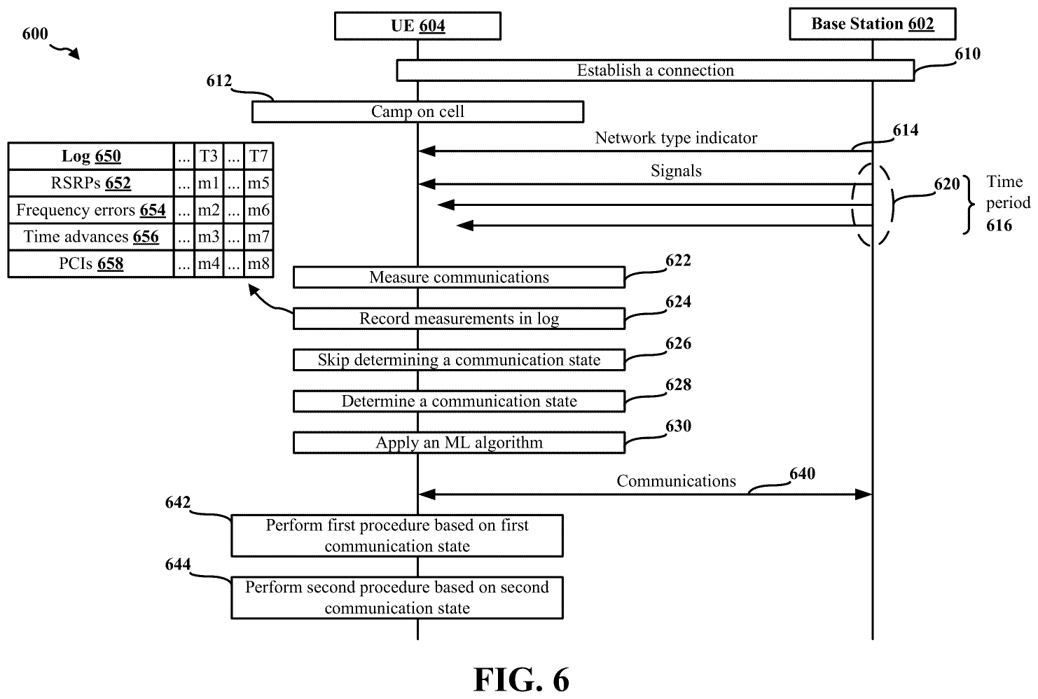

FIG. 6 illustrates an example communication flow 600 between a base station 602 and a UE 604, as presented herein. One or more aspects described for the base station 602 may be performed by a component of a base station or a network entity, such as a CU, a DU, and/or an RU. In the illustrated example, the communication flow 600 facilitates the UE 604 determining a communication state of the UE and communicating based on the communication state. Aspects of the base station 602 may be implemented by the base station 102 of FIG. 1 and/or the base station 310 of FIG. 3. Aspects of the UE 604 may be implemented by the UE 104 of FIG. 1 and/or the UE 350 of FIG. 3. Although not shown in the illustrated example of FIG. 6, in additional or alternative examples, the base station 602 may be in communication with one or more other base stations or UEs, and/or the UE 604 may be in communication with one or more other base stations or UEs.

In the illustrated example of FIG. 6, at 610, the UE 604 and the base station 602 establish a connection. For example, the UE 604 and the base station 602 may perform an RRC connection procedure or an RRC reconnection procedure. At 612, the UE 604 camps on a cell associated with the base station 602. For example, the UE 604 may transition to an idle state after establishing the connection with the base station 602.

As shown in FIG. 6, the base station 602 may transmit signals 620 that are received by the UE 604. The signals 620 may include one or more communications that are associated with respective metrics. In the example of FIG. 6, the UE 604 receives the signals 620 over a time period 616.

At 622, the UE 604 performs measurements on the signals 620 received over the time period 616. For example, the UE 604 may measure RSRPs 652 associated with the signals 620. The UE 604 may measure frequency errors 654 associated with the signals 620. In some examples, the UE 604 may generate or measure a time advance associated with an NTA associated with the signals 620. The time advance associated with the NTA may correspond to a timing advance value based on a propagation delay between when a signal is transmitted by the base station 602 and received by the UE 604. In such examples, the UE 604 may measure time advances 656 associated with the signals 620. In some examples, the UE 604 may measure a rate of PCI change based on PCIs 658 associated with the signals 620.

At 624, the UE 604 may record the measurements in a log. For example, the UE 604 may record the measurements in a log 650. The measurements included in the log 650 may provide a continual time series data stream. For example, the log 650 includes measurements at a time T3 and at a time T7. In some examples, the entries in the log 650 may be based on respective signals of the signals 620. For example, the UE 604 may receive a first signal of the signals 620 at the time T3 and record measurements m1 to m4 based on the RSRP, frequency error, time advance, and PCI, respectively, associated with the first signal. In a similar manner, the UE 604 may log measurements m5 to m8 based on the RSRP, frequency error, time advance, and PCI, respectively, associated with a second signal of the signals 620 that is received at the time T7.

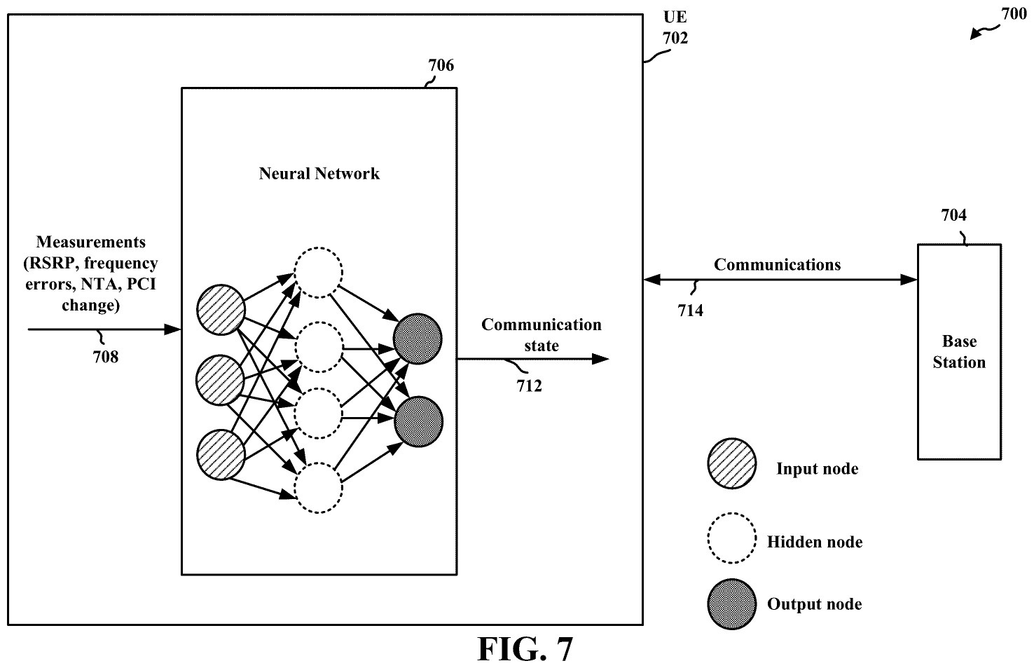

At 628, the UE 604 may determine a communication state. For example, the UE 604 may use the measurements recorded in the log 650 to determine the communication state of the UE 604. For example, the UE 604 may determine whether the UE 604 is in an HST state or a non-HST state. The UE 604 may additionally or alternatively determine whether the UE 604 is in a moving state or a stationary state. In some examples, the UE 604 may apply, at 630, an ML algorithm to the measurements to determine the communication state of the UE 604. Aspects of applying the ML algorithm are described in connection with FIGS. 7 to 10. The ML algorithm may use patterns in the measurements to determine the communication state. For example, in an HST state, the RSRP may be less than or equal to −70 dBm (e.g., as the UE is not likely to be close to a base station), the frequency error may jump disruptively with a gap after a PCI handover procedure, and the time advance may be continuous and with a delta that is within 50 (e.g., as the distance to the base station does not change much even after a PCI change). In contrast, when the UE is in the non-HST state, the time advance jump gaps may be observed after PCI handover procedures since the distance between the UE and the base stations are different before and after performing the PCI handover procedure.

As shown in FIG. 6, the UE 604 and the base station 602 may exchange communications 640 based on the communication state. In some examples, the UE 604 may perform different types of procedures and/or modify aspects of procedures based on the communication state. For example, the UE 604 may perform a first procedure 642 based on a first communication state, or the UE 604 may perform a second procedure 644 based on a second communication state.

In some examples, the first procedure 642 and the second procedure 644 may be associated with a handover procedure. For example, the UE 604 may perform a handover procedure when the UE 604 is camping on a non-HST cell (e.g., the first procedure 642), or may perform a fast handover procedure when the UE 604 is camping on an HST cell (e.g., the second procedure 644). The UE 604 may perform the handover procedure by performing measurements on nearby cells and then switching to one of the nearby cells based on the measurements. When performing a fast handover procedure, the UE 604 may predict a target base station with which perform to perform a handover procedure. Performing the fast handover may be beneficial when the UE 604 is moving at a high speed, such as when the UE 604 is in a moving state on an HST (e.g., the third UE 426 located in the HST 428 of FIG. 4). In some examples, the first procedure 642 and the second procedure 644 may be associated with channel estimation techniques. In some examples, the first procedure 642 and the second procedure 644 may be associated with control channel decoding techniques.

In some examples, performing the second procedure 644 may be based on modifying aspects of the first procedure 642. For example, when the UE 604 is in an idle mode, the UE 604 may identify new cells and perform measurements of the identified cells. The UE 604 may also evaluate whether a newly detected cell meets a reselection criteria within a period T_{detect,NR_Intra} or a previously detected cells meets the reselection criteria within a period T_{evaluate,NR_Intra}. To facilitate the UE 604 determining whether the cell meets the reselection criteria, the UE 604 may perform measurements at least every period T_{measure,NR_Intra}. The measurements may include at least an RSRP and/or an RSRQ. The values of the periods (T_{detect, NR_Intra}, T_{evaluate, NR_Intra}, T_{measure, NR_Intra}) may depend on the communication state of the UE 604. Table 1 (below) illustrates periods (T_{detect,NR_Intra}, T_{evaluate,NR_Intra}, T_{measure,NR_Intra}) when the UE 604 is in a non-HST state. Table 2 (below) illustrates periods (T_{detect,NR_Intra}, T_{evaluate, NR_Intra}, T_{measure, NR_Intra}) when the UE 604 is in an HST state. In the examples of Table 1 and Table 2, the periods (T_{detect, NR_Intra}, T_{evaluate, NR_Intra}, T_{measure, NR_Intra}) are in the context of discontinuous reception (DRX) cycles. The UE 604 may use Table 1 to perform the first procedure 642. The UE 604 may use Table 2 to perform the second procedure 644.

TABLE 1
UE in non-HST state

| DRX | Scaling | | T_{detect,NR}_Intra | T_{measure,NR}_Intra | |
|---|---|---|---|---|---|
| cycle | Factor | | [s] | [s] (number | T_{evaluate,NR}_Intra |
| length | (N1) | | (number of | of | [s] (number of |
| [s] | FR1 | FR2^{Note1} | DRX cycles) | DRX cycles) | DRX cycles) |
| 0.32 | 1 | 8 | 11.52 × N1 × | 1.28 × | 5.12 × |
| | | | M2 (36 × | N1 × M2 | N1 × M2 |
| | | | N1 × M2) | (4 × N1 × M2) | (16 × N1 × M2) |
| 0.64 | | 5 | 17.92 × N1 | 1.28 × N1 (2 × | 5.12 × N1 (8 × |
| | | | (28 × N1) | N1) | N1) |
| 1.28 | | 4 | 32 × N1 (25 × | 1.28 × N1 (1 × | 6.4 × N1 (5 × |
| | | | N1) | N1) | N1) |
| 2.56 | | 3 | 58.88 × N1 | 2.56 × N1 (1 × | 7.68 × N1 (3 × |
| | | | (23 × N1) | N1) | N1) |

Note 1:
Applies for UE supporting power class 2&3&4. For UE supporting power class 1 or 5, N1 = 8 for all DRX cycle length.
Note 2:
M2 = 1.5 if SMTC periodicity of measured intra-frequency cell >20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_intra is expected.

TABLE 2
UE in HST state

| DRX | T_{detect,NR}_Intra | | |
|---|---|---|---|
| cycle | [s] | T_{measure,NR}_Intra | T_{evaluate,NR}_Intra |
| length | (number of | [s] (number of | [s] (number of |
| [s] | DRX cycles) | DRX cycles) | DRX cycles) |
| 0.32 | 2.56 × M2 | 0.32 × M3 | 0.96 × M4 |
| | (8 × M2) | (1 × M3) | (3 × M4) |
| 0.64 | 5.12 (8) | 0.64 (1) | 1.92 (3) |
| 1.28 | 8.96 (7) | 1.28 (1) | 3.84 (3) |
| 2.56 | 58.88 (23) | 2.56 (1) | 7.68 (3) |

Note 1:
when SMTC <=40 ms, M2 = M3 = M4 = 1; and when SMTC >40 ms, M2 = 1.5, M3 = M4 = 2
Note 2:
When highSpeedMeasFlag-r16 is configured, the requirements apply only to UE supporting either measurementEnhancement-r16 or [intraRAT-MeasurementEnhancement-r16].

In examples in which the UE 604 is in a connected mode, the UE 604 may use Table 3 (below) to determine a measurement period T_{SSB_measurement_period_intra}. In the example of Table 3, the measurement periods are based on when the UE is in an HST state. Additionally, the measurement period is with respect to SSBs.

TABLE 3
UE in HST state

| DRX cycle | T_{SSB}_measurement_period_intra |
|---|---|
| No DRX ^{Note 2} | max(200 ms, ceil( 5 × Kₚ) × SMTC |
| | period)^{Note 1} × CSSFᵢₙₜᵣₐ |
| DRX cycle ≤160 ms | max(200 ms, ceil(5 × M2 ^{Note 2} × Kₚ) × |
| | max(SMTC period, DRX cycle)) × |
| | CSSFᵢₙₜᵣₐ |
| 160 ms < DRX cycle ≤320 ms | ceil(4 × M2 ^{Note 2} × Kₚ) × DRX cycle × |
| | CSSFᵢₙₜᵣₐ |
| DRX cycle >320 ms | ceil( Y ^{Note 3} × Kₚ ) × DRX cycle × |
| | CSSFᵢₙₜᵣₐ |

NOTE 1:
If different SMTC periodicities are configured for different cells, the SMTC period in the requirement is the one used by the cell being identified
NOTE 2:
M2 = 1.5 if SMTC period >40 ms, otherwise M2 = 1
NOTE 3:
Y = 3 when SMTC period <=40 ms, Y = 5 when SMTC period >40 ms
NOTE 4:
When highSpeedMeasFlag-r16 is configured, the requirements apply only to UE supporting either measurementEnhancement-r16 or [intraRAT-MeasurementEnhancement-r16] on measurements of the primary component carrier and do not apply to measurements of a secondary component carrier with active SCell.

In some examples, the base station 602 may transmit a network type indicator 614 associated with a mobility condition of the associated cell. For example, when the base station 602 is associated with an HST cell, such as the first HST base station 422 and the second HST base station 432 of FIG. 4, the network type indicator 614 may indicate that the base station 602 is an HST base station. In some examples, the network type indicator 614 may be set to a first value to indicate to the UE 604 that the base station 602 is an HST base station, and the network type indicator 614 may be set to a second value to indicate to the UE 604 that the base station 602 is a non-HST base station, such as the non-HST base station 402 of FIG. 4.

In some examples, the network type indicator 614 may include an information element (IE), which may be referred to as “HighSpeedConfig” or by any other suitable name, used to configure parameters for high speed scenarios. The HighSpeedConfig 1E may include a field, which may be referred to as “highSpeedMeasFlag” or by any other suitable name, that indicates that the UE is to perform measurements that support high speed, such as up to 500 kilometers per hour (km/h). For example, when the highSpeedMeasFlag is enabled, the UE 604 may apply the periods of Table 2 or Table 3, and when the highSpeedMeasFlag is disabled, the UE 604 may apply the periods of Table 1.

In some examples, the UE 604 may skip, at 626, determining a communication state of the UE 604 based on the network type indicator 614. For example, when the network type indicator 614 indicates to the UE 604 that the base station 602 is a non-HST base station (e.g., the highSpeedMeasFlag is disabled), the UE 604 may skip or forgo determining the communication state of the UE. In some examples, the UE 604 may skip determining the communication state of the UE to conserve resources associated with determining the communication state of the UE. For example, when the network type indicator 614 indicates to the UE 604 that the base station 602 is a non-HST base station, the UE 604 may determine to apply legacy procedures, such as the example procedures associated with the first procedure 642. However, when the network type indicator 614 indicates to the UE 604 that the base station 602 is an HST base station, the UE 604 may apply the first procedure 642 or may apply the second procedure 644 to communicate with the base station 602. Thus, when the network type indicator 614 indicates to the UE 604 that the base station 602 is a non-HST base station, the UE 604 may conserve resources by skipping the determining of the communication state of the UE.

In some examples, when the UE 604 is determining the communication state of the UE, the UE 604 may apply an ML algorithm to determine different communication states. For example, the UE 604 may apply an ML algorithm to determine the communication state of the UE based on the network type indicator 614 (e.g., when the highSpeedMeasFlag is enabled). The UE 604 may forgo applying an ML algorithm when the highSpeedMeasFlag is disabled. In some examples, when the UE 604 is determining the communication state of the UE, the UE 604 may apply multiple instances of an ML algorithm to determine different communication states. For example, the UE 604 may apply a first instance of an ML algorithm to determine whether the UE 604 is in an HST state or a non-HST state. The UE 604 may apply a second instance of an ML algorithm to determine whether the UE 604 is located on the HST or not located on the HST. The UE 604 may apply a third instance of an ML algorithm to determine whether the UE 604 is in a moving state or in a stationary state.

A UE may use ML algorithms, deep-learning algorithms, neural networks, or advanced signal processing methods for aspects of wireless communication, for example, with a base station. In some aspects described herein, a UE may train one or more neural networks to learn dependence of measured qualities on individual parameters.

FIG. 7 illustrates a diagram 700 of a UE 702 that includes a neural network 706 configured to determine a communication state 712 of the UE 702. The communication state 712 of the UE may be used by the UE 702 for communications 714 with a base station 704.

Among others, examples of ML models or neural networks that may be comprised in the UE 702 include artificial neural networks (ANN), such as a recurrent neural network (RNN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; Deep convolutional networks (DCNs) configured with additional pooling and normalization layers; and Deep belief networks (DBNs).

An ML model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the ML model. Machine learning may provide non-linear statistical data model or decision making and may model complex relationships between input data and output information.

An ML model may include multiple layers and/or operations that may be formed by concatenation of one or more of the referenced operations. Examples of operations that may be involved include extraction of various features of data, convolution operations, fully connected operations that may be activated or deactivates, compression, decompression, quantization, flattening, etc. As used herein, a “layer” of an ML model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained ML model. Different layers of an ML model may be trained separately.

Machine learning models may include a variety of connectivity patterns, for example, including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

An ML model or neural network may be trained. For example, an ML model may be trained based on supervised learning or reinforcement learning. During training, the ML model may be provided with input that the model uses to compute to produce an output. The actual output may be compared to a target output, and the difference may be used to adjust parameters (such as weights and biases) of the ML model in order to provide an output closer to the target output. Before training, the output may be incorrect or less accurate, and an error, or difference, may be calculated between the actual output and the target output. The weights of the ML model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The ML models may include computational complexity and substantial processing for training the ML model. FIG. 7 illustrates that the example neural network 706 may include a network of interconnected nodes. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network 706 may include any number of nodes and any type of connections between nodes. The neural network 706 may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times.

As described above, in a wireless communication environment, communications between a base station and a UE may be associated with different characteristics. For some characteristics, the UE may have the ability to determine that the UE is camping on an HST cell and that the UE is located on an HST (e.g., as described in connection with the third UE 426 of FIG. 4). For other characteristics, the UE may have the ability to determine that the UE is camping on an HST cell and that the UE is not located on an HST (e.g., as described in connection with the second UE 424 of FIG. 4). The UE may use the communication state of the UE to determine a procedure to apply when communicating with the base station, as described in connection with the first procedure 642 (e.g., when the UE is in a non-HST state) and the second procedure 644 (e.g., when the UE is in an HST state).

In aspects disclosed herein, over time, the UE may utilize a neural network to learn characteristics of measurements associated with communication states. The UE may then communicate with the base station based on a communication state 712.

As disclosed herein, a machine learning component or a neural network may be trained over time using measurements 708 performed on one or more communications received over a time period, such as the example signals 620 over the time period 616 of FIG. 6. The measurements 708 may include measured RSRPs, measured frequency errors, such as Frequency Tracking Loop (FTL) errors, measured time advances associated with NTAs, and/or measured rates of PCI change. The measurements 708 may provide a continual time series data stream or time sequence data, as described in connection with the log 650 of FIG. 6. Additionally, the communication state 712 may be determined to improve communication with the base station 704.

For example, the UE may perform a handover procedure when the communication state indicates that the UE is camping on an HST cell and not located on an HST (e.g., as described in connection with the second UE 424 of FIG. 4), and the UE may perform a fast handover procedure when the communication state indicates that the UE is camping on an HST cell and located on an HST (e.g., as described in connection with the third UE 426 of FIG. 4). As another example, the UE may perform a first channel estimation procedure when the communication state indicates that the UE is camping on an HST cell and not located on an HST (e.g., as described in connection with the second UE 424 of FIG. 4), and the UE may perform a second channel estimation procedure when the communication state indicates that the UE is camping on an HST cell and located on an HST (e.g., as described in connection with the third UE 426 of FIG. 4). As another example, the UE may perform a first control channel decoding procedure when the communication state indicates that the UE is camping on an HST cell and not located on an HST (e.g., as described in connection with the second UE 424 of FIG. 4), and the UE may perform a second control channel decoding procedure when the communication state indicates that the UE is camping on an HST cell and located on an HST (e.g., as described in connection with the third UE 426 of FIG. 4). As another example, the UE may use the measurement periods of Table 1 (above) when the UE is camping on a non-HST cell (e.g., as described in connection with the first UE 404 of FIG. 4) or is camping on an HST cell and not located on an HST (e.g., as described in connection with the second UE 424 of FIG. 4), and the UE may use the measurement periods of Table 2 or Table 3 (above) when the UE is camping on an HST cell and located on an HST (e.g., as described in connection with the third UE 426 of FIG. 4).

Thus, the UE 702 may utilize a neural network to learn over time an improved determination of a communication state 712 of the UE. Machine learning may be performed at the UE 702 to execute training procedures based on the measurements 708 performed on communications received over a time period. Such training procedures may provide an improved/modified determination of a communication state 712 to be used for applying a communication procedure (e.g., a handover procedure, a channel estimation procedure, a control channel decoding procedure, etc.) to the communications 714 with the base station.

The UE 702 may determine the communication state 712 to be used for determining the communication procedure at an increased level of granularity via machine learning. For example, the UE 702 may determine the communication state 712 based on abrupt changes in characteristics associated with the measurements 708, for example, as described in connection with moving from the location L2 of the first HST cell 510 to the location L3 of the second HST cell 520 of FIG. 5.

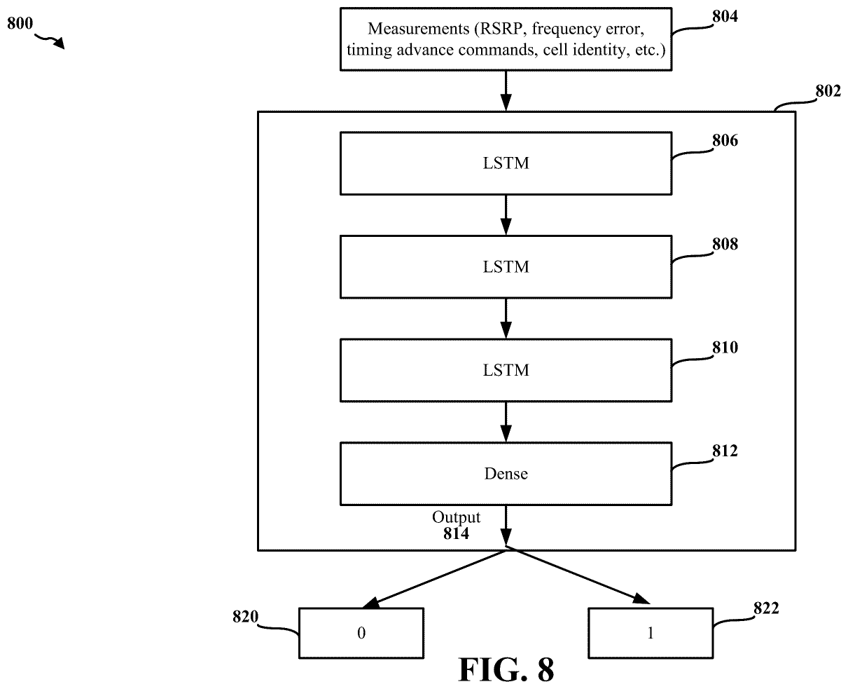

FIG. 8 is a diagram 800 of an example neural network processing technique to determine a communication state of a UE, as presented herein. In the example of FIG. 8, the neural network processing technique includes a neural network 802 employing an LSTM architecture. Aspects of the neural network 802 may be implemented by the neural network 706 of FIG. 7.

As shown in FIG. 8, the neural network 802 receives measurements 804. The measurements 804 may include RSRP, frequency error, timing advance commands (e.g., time advances associated with NTAs), cell identities, etc., as described in connection with the log 650 of FIG. 6 and/or the measurements 708 of FIG. 7. The measurements 804 may be associated with different characteristics based on the communication state of the UE. In some examples, the measurements 804 may include a time sequence of measurements. For example, the measurements 804 may be performed on one or more signals received over a time period, such as the signals 620 received over the time period 616 of FIG. 6.

In the example of FIG. 8, the neural network 802 includes a plurality of layers. Each of the layers employ an LSTM architecture. The LSTM architecture is an ML model that is advantageous to use when processing a long time sequence of data, such as over the time period 616 of FIG. 6. As shown in FIG. 8, the neural network 802 includes a first LSTM layer 806, a second LSTM layer 808, and a third LSTM layer 810. The first LSTM layer 806, the second LSTM layer 808, and the third LSTM layer 810 may be associated with different instances of the LSTM architecture on data (e.g., a same batch of data, such as the measurements 804).

As shown in FIG. 8, the neural network 802 includes a dense layer 812. The dense layer 812 may be a fully connected layer, as described in connection with FIG. 7. The dense layer 812 may be used to convert a larger number of dimensional inputs to an output 814 that is a smaller dimensional output. For example, the dense layer 812 may convert an 8-dimensional input to a 2-dimensional output (e.g., “0” or “1”). With respect to HST, the output 814 of the dense layer 812 may be a first value 820 (“0”) to indicate that the UE is in a non-HST state. The output 814 of the dense layer 812 may be second value 822 (“1”) to indicate that the UE is in in an HST state.

Although the example neural network 802 of FIG. 8 includes three example LSTM layers, other examples may include other suitable quantities of LSTM layers.

Although the output 814 of the neural network 802 of FIG. 8 indicates an HST state or non-HST state of the UE, in other examples, the output of the neural network may indicate additional or alternate states. For example, the output may indicate whether the UE is in an elevator state or a non-elevator state. In another example, the output may indicate whether the UE is in a moving state or a stationary state.

In some examples, the weights associated with the neural network 802 may be adjusted based on the type of output. For example, a first instance of the neural network 802 may include first weights to facilitate determining the HST state of the UE, a second instance of the neural network 802 may include second weights to facilitate determining the elevator state of the UE, a third instance of the neural network 802 may include third weights to facilitate determining a moving or stationary state of the UE, etc.

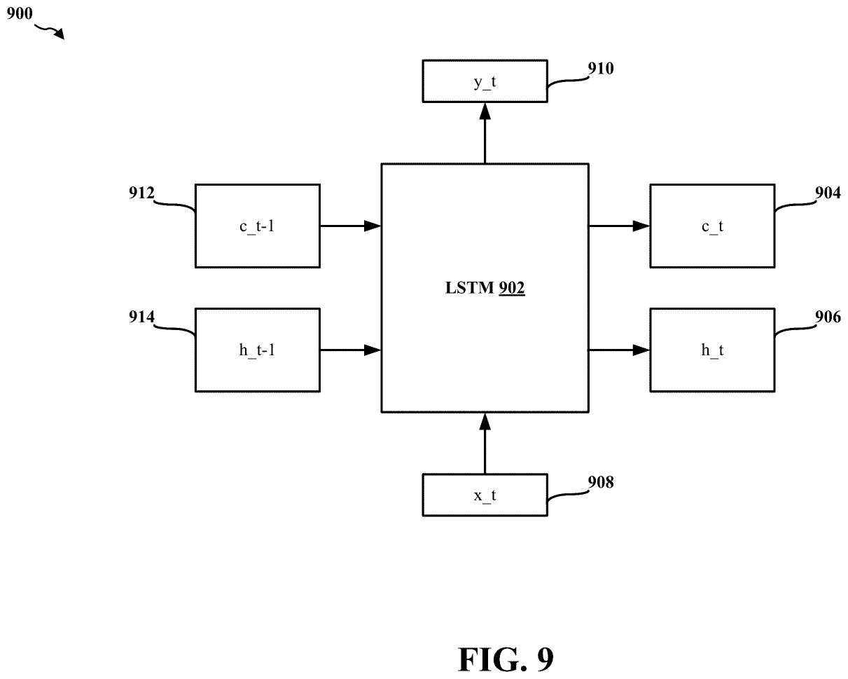

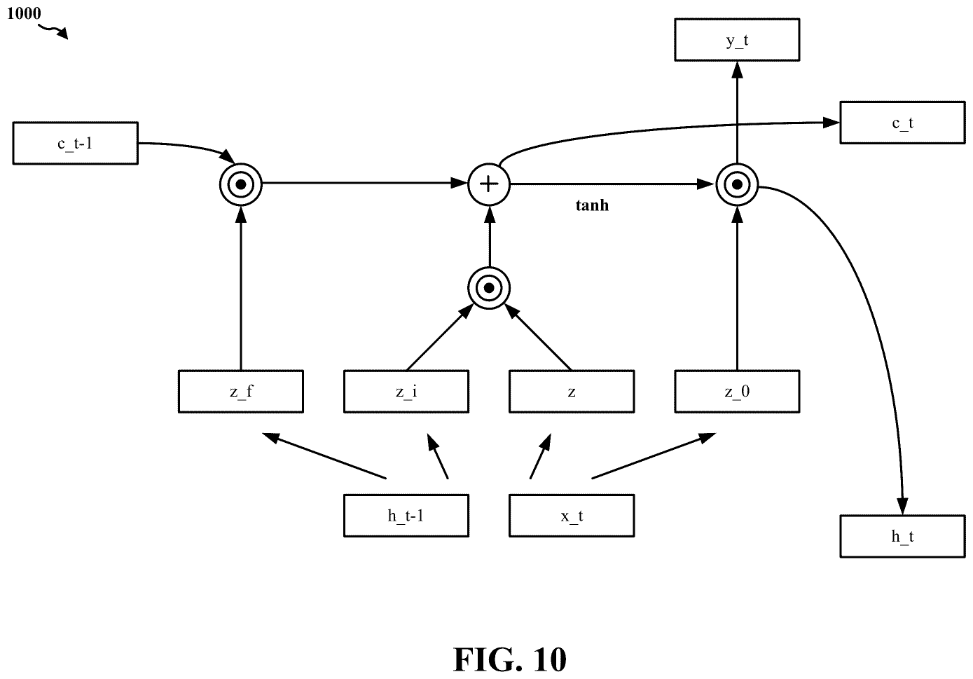

FIG. 9 and FIG. 10 illustrate examples of an LSTM cell. FIG. 9 is a diagram 900 of an example LSTM cell 902, as presented herein. LSTM is a variant of RNN, which includes a cell state 904 (cₜ). The cell state 904 may correspond to long history memory. A previous cell state 912 (cₜ₋₁) corresponds to the value of the long history memory at a previous time. The LSTM cell 902 also includes a hidden state 906 (hₜ) corresponding to short term memory. A previous hidden state 914 (hₜ₋₁) may correspond to the value of the short term memory at a previous time. In the example of FIG. 9, new information 908 (xₜ) is input for the current step. Additionally, output 910 (yₜ) is the output desired for the LSTM cell 902. In some examples, the output 910 may correspond to the output 814 of FIG. 8.

In examples of multiple-input and single-output scenarios, the output 910 may be interpreted as a categorization. For example, the output 910 may correspond to a categorization of UE mobility, such as whether the UE is in an HST, whether the UE is in an elevator, whether the UE is in a subway, whether the UE is moving, etc.

The cell state may change slowly when the previous cell state 912 is added by something resulting in the cell state 904.

The hidden state may change faster when the hidden state 906 and the previous hidden state 914 are different.

FIG. 10 is a diagram of another example LSTM cell 1000, as presented herein. In the example of FIG. 10, the LSTM includes a cell state (cₜ) for a long history information transfer and short term memory (hₜ) for selective information memory. The LSTM cell 1000 also includes a final output (yₜ). In the example of FIG. 10, the cell state (cₜ) may be defined by equation 1 (below), the short term memory (hₜ) may be defined by equation 2 (below), and the final output (yₜ) may be defined by equation 3 (below).

$${c}^{t} = {z}^{f} ⊙ {c}^{t - 1} + {z}^{i} ⊙ z \qquad Equation 1$$

$${h}^{t} = {z}^{0} ⊙ tanh ( {c}^{t} ) \qquad Equation 2$$

$${y}^{t} = σ ( {W}^{′} {h}^{t} ) \qquad Equation 3$$

In the example of FIG. 10, the term σ represents the logic sigmoid activation function, with a range of [0, 1]. The value “0” may represent that information is blocked and the value “1” may be used to pass information or to activate information.

In the example of FIG. 10, the symbol ⊙ represents the Hadamard product, which means the corresponding elements in a matrix are multiplied. The Hadamard product is a binary operation that takes two matrices of the same dimensions and produces another matrix of the same dimension as the operands. The symbol ⊕ represents the Hadamard addition in which the corresponding elements in the matrices are added.

The internal architecture of the LSTM cell 1000 includes three layers (e.g., a forget layer (z_{f}), an information layer (zᵢ) and (z), and an output layer (zₒ)) that regulate relevant information to be transferred and not relevant information to be forgotten. In the example of FIG. 10, the information layer (z) may be defined by equation 4 (below), the information layer (zᵢ) may be defined by equation 5 (below), the forget layer (z_{f}) may be defined by equation 6 (below), and the output layer (zₒ) may be defined by equation 6 (below).

$$z = tanh ( {W}_{{h}^{t - 1}}^{{x}^{t}} ) \qquad Equation 4$$

$${z}^{i} = σ ( {W}_{{h}^{t - 1}}^{{i}^{{x}^{t}}} ) \qquad Equation 5$$

$${z}^{f} = σ ( {W}_{{h}^{t - 1}}^{{f}^{{x}^{t}}} ) \qquad Equation 6$$

$${z}^{o} = σ ( {W}_{{h}^{t - 1}}^{{o}^{{x}^{t}}} ) \qquad Equation 7$$

In Equations 4 to 7, the terms W, Wⁱ, W^{f}, and Wⁱ represent weights coefficients to be converged. When the model is trained, the weights may be configured to output a scenario with relative precision and accuracy.

The forget layer (z_{f}), as defined by Equation 6, is used to forget irrelevant information from previous long history memory (cₜ₋₁). The forget layer (z_{f}), sometimes referred to as a “forget gate,” is based on previous short-term memory (hₜ₋₁) and new input data (xₜ). The information layer (z), as defined by Equation 4, is a hidden layer input that is used to store the new input data (xₜ) and previous short-term memory (hₜ₋₁) with an appropriate weight (w) and is transformed by a tan h function to ensure the output data value is within (−1,1) as the standard data format. The information layer (zᵢ), as defined by Equation 5, is the information gate that regulates what relevant information is stored. The sigmoid function for the information layer (zᵢ) is also based on the previous short-term memory (hₜ₋₁) and the new input data (xₜ), but is modified with a different weight Wⁱ. The output from the forget layer (z_{f}) and the hidden layer (e.g., the information layer (z)) are added to form a new cell state (cₜ).

In the example of FIG. 10, the output layer (zₒ) produces a current hidden state (e.g., a current short term memory (hₜ) for transferring as the short-term memory for the next step. The output layer (zₒ) is based on the current cell state (cₜ) and regulated by the output gate that is controlled by the short-term input of the new input data (xₜ) and the previous short-term memory (hₜ₋₁).

In the example of FIG. 10, the final output (yₜ) is based on the current hidden state (e.g., the current short term memory (hₜ)) with the weighted information (e.g., the weight W′), and is transformed by the sigmoid function for practical usage within the LSTM cell 1000.

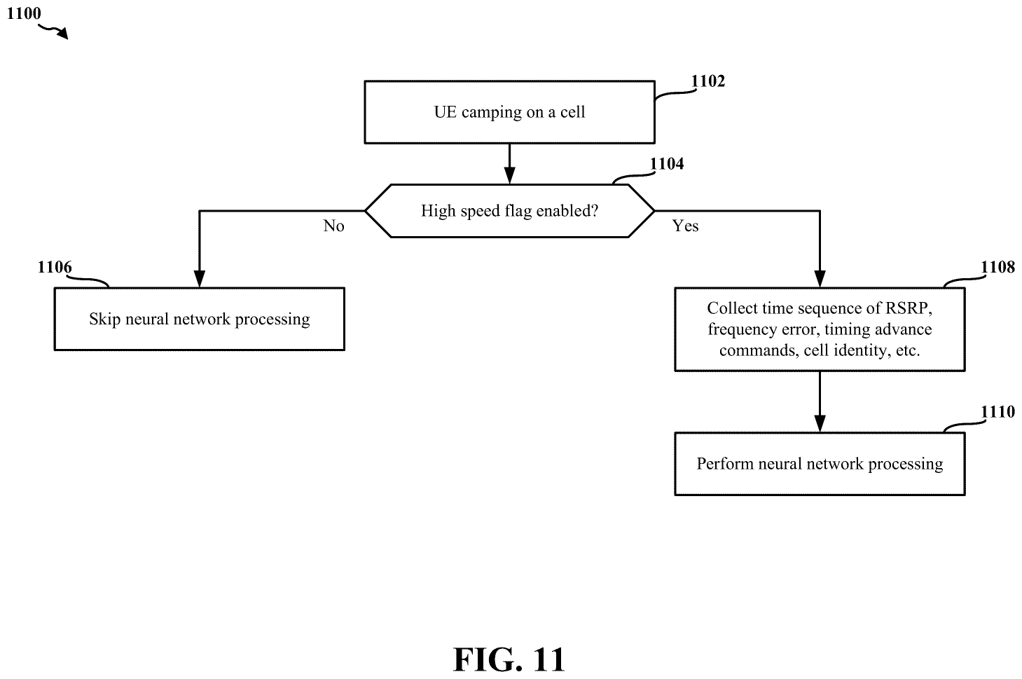

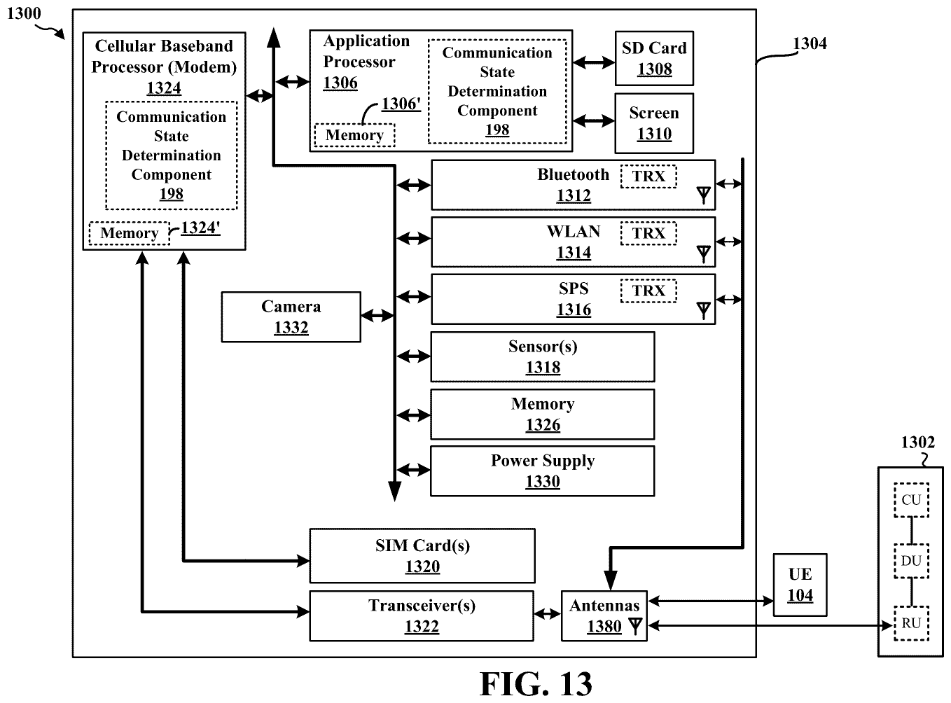

FIG. 11 is a flowchart 1100 of a method of wireless communication, as presented herein. The method may be performed by a UE (e.g., the UE 104, and/or an apparatus 1304 of FIG. 13). The method may facilitate improving mobility performance by enabling the UE to determine a communication state of the UE, for example, with respect to a network node. In the example of FIG. 11, the communication state is associated with an HST.

At 1102, the UE is camping on a cell, as described in connection with 612 of FIG. 6. For example, the UE may establish a connection with a base station that is associated with the cell and transition to an idle state.

At 1104, the UE may determine whether a high speed flag is enabled, as described in connection with the network type indicator 614 of FIG. 6. For example, the high speed flag may be enabled when the network type indicator 614 is set to a first value and the high speed flag may be disabled when the network type indicator 614 is set to a second value.

If, at 1104, the UE determines that the high speed flag is disabled (e.g., the network type indicator 614 is set to the second value), then, at 1106, the UE may skip neural network processing, as described in connection with 624 of FIG. 6. For example, the UE may skip performing the neural network processing to determine a communication state of the UE.

If, at 1104, the UE determines that the high speed flag is enabled (e.g., the network type indicator 614 is set to the first value), then, at 1108, the UE may collect a time sequence of measurements, as described in connection with 622 of FIG. 6. The measurements may include RSRP, frequency error, timing advance commands, cell identifiers, etc. The time sequence of measurements may include measurements performed on one or more communications received over a time period, such as the signals 620 over the time period 616 of FIG. 6.

At 1110, the UE performs neural network processing to determine the communication state of the UE, as described in connection with 628 of FIG. 6. For example, the UE may apply an ML algorithm employing an LSTM architecture to determine the communication state of the UE, as described in connection with 630 of FIG. 6 and the examples of FIGS. 7 to 10.

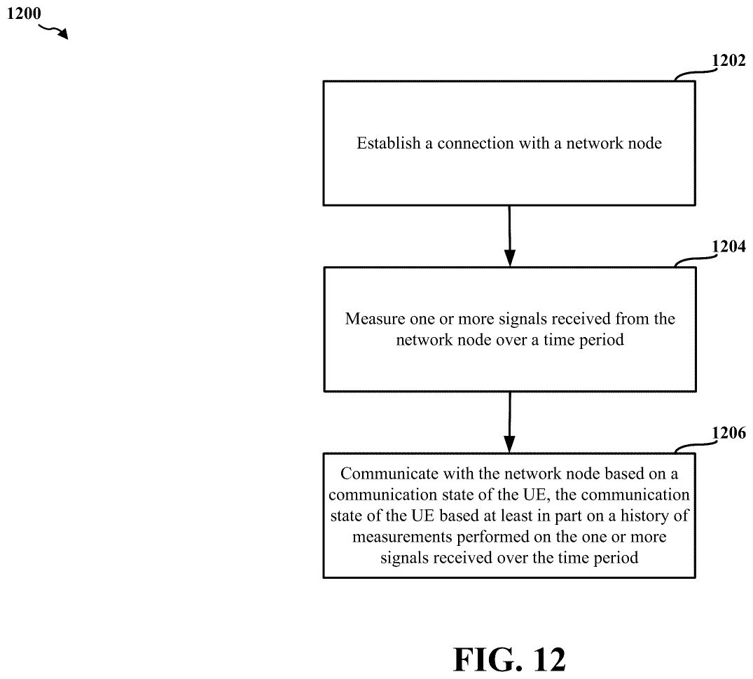

FIG. 12 is a flowchart 1200 of a method of wireless communication. The method may be performed by a UE (e.g., the UE 104, and/or an apparatus 1304 of FIG. 13). The method may facilitate improving mobility performance by enabling the UE to determine a communication state of the UE, for example, with respect to a network node.

At 1202, the UE establishes a connection with a network node, as described in connection with 610 of FIG. 6. For example, 1202 may be performed by a cellular RF transceiver 1322/the communication state determination component 198 of the apparatus 1304 of FIG. 13.

At 1204, the UE measures one or more signals received from the network node over a time period, as described in connection with 622 and the signals 620 of FIG. 6. For example, 1204 may be performed by the cellular RF transceiver 1322/the communication state determination component 198 of the apparatus 1304 of FIG. 13.

At 1206, the UE communicates with the network node based on a communication state of the UE, as described in connection with communications 640 of FIG. 6. For example, 1206 may be performed by the cellular RF transceiver 1322/the communication state determination component 198 of the apparatus 1304 of FIG. 13.

The communication state of the UE may be based at least in part on a history of measurements performed on the one or more signals received over the time period. In some examples, the communication state may indicate an association with an HST. In some examples, the communication state may indicate an association with a location within an elevator. In some examples, the communication state may be associated with an ambient condition of the UE.

In some examples, the communication state of the UE is associated with a mobility state of the UE. For example, the UE may receive a network type indicator associated with a mobility condition while communicating with the network node, as described in connection with the network type indicator 614 of FIG. 6. In such examples, the UE may measure (e.g., at 1204) the one or more signals over the time period based on the network type indicator being associated with the mobility condition.

In some examples, the UE may skip determining the communication state for a network indicating a second network type indicator that is not associated with the mobility condition. For example, the UE may skip determining the communication state for the network when the second network type indicator is associated with a non-HST network, as described in connection with 626 of FIG. 6. In some such examples, the network type indicator may indicate that the network node is associated with a non-HST cell.

In some examples, the network type indicator may indicate that the network node is associated with an HST cell. In some such examples, the communication state may indicate that the UE is in a moving state or a stationary state with the HST cell and that the UE is located in the HST. In other examples, the communication state may indicate that the UE is in a moving state or a stationary state with the HST and that the UE is not located in the HST.

In some examples, the measurements (e.g., at 1204) may include at least one of: an RSRP, a frequency error, and a time advance associated with an NTA. In some examples, the frequency error may include an FTL error. In some examples, the communication state may be further based on a PCI change.

In some examples, the UE may apply a machine learning algorithm to the history of the measurements to detect the communication state of the UE (e.g., at 1206). In some examples, the machine leaning algorithm may include an LSTM architecture.

In some examples, the UE may apply a first instance of a machine learning algorithm to detect a first communication state of the UE, the first communication state indicating that the network node is associated with an HST cell or associated with a non-HST cell, as described in connection with 630 of FIG. 6. In some examples, the UE may apply one or more additional instances of the ML algorithm. For example, the UE many apply a second instance of the ML algorithm to determine whether the UE is in a moving state or a stationary state.

In some examples, communicating with the network node based on the communication state of the UE (e.g., at 1206) includes performing a first handover procedure when the communication state is a first communication state (e.g., as described in connection with the first procedure 642 of FIG. 6), or performing a second handover procedure when the communication state is a second communication state, the first handover procedure being a different handover type than the second handover procedure, the first communication state being a different state than the second communication state (e.g., as described in connection with the second procedure 644 of FIG. 6). For example, the UE may perform a handover procedure when the communication state indicates that the UE is camping on a non-HST cell. The UE may perform a fast handover procedure when the communication state indicates that the UE is camping on an HST cell.

In some examples, communicating with the network node based on the communication state of the UE (e.g., at 1206) includes performing a first channel estimation procedure when the communication state is a first communication state, or performing a second channel estimation procedure when the communication state is a second communication state, the first channel estimation procedure being a different channel estimation type than the second channel estimation procedure, the first communication state being a different state than the second communication state.

In some examples, communicating with the network node based on the communication state of the UE (e.g., at 1206) includes performing a first control channel decoding procedure when the communication state is a first communication state, or performing a second control channel decoding procedure when the communication state is a second communication state, the first control channel decoding procedure being a different control channel decoding type than the second control channel decoding procedure, the first communication state being a different state than the second communication state.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers (e.g., the cellular RF transceiver 1322). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize one or more antennas 1380 for communication. The cellular baseband processor 1324 communicates through transceiver(s) (e.g., the cellular RF transceiver 1322) via one or more antennas 1380 with the UE 104 and/or with an RU associated with a network entity 1302. The cellular baseband processor 1324 and the application processor 1306 may each include a computer-readable medium/memory, such as the on-chip memory 1324′, and the on-chip memory 1306′, respectively. The additional memory modules 1326 may also be considered a computer-readable medium/memory. Each computer-readable medium/memory (e.g., the on-chip memory 1324′, the on-chip memory 1306′, and/or the additional memory modules 1326) may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see the UE 350 of FIG. 3) and include the additional modules of the apparatus 1304.

As discussed supra, the communication state determination component 198 is configured to establish a connection with a network node; measure one or more signals received from the network node over a time period; and communicate with the network node based on a communication state of the UE, the communication state of the UE based at least in part on a history of measurements performed on the one or more signals received over the time period.

The communication state determination component 198 may be within the cellular baseband processor 1324, the application processor 1306, or both the cellular baseband processor 1324 and the application processor 1306. The communication state determination component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1304 may include a variety of components configured for various functions. For example, the communication state determination component 198 may include one or more hardware components that perform each of the blocks of the algorithm in the flowcharts of FIGS. 11 and/or 12.

In one configuration, the apparatus 1304, and in particular the cellular baseband processor 1324 and/or the application processor 1306, includes means for establishing a connection with a network node. The example apparatus 1304 also includes means for measuring one or more signals received from the network node over a time period. The example apparatus 1304 also includes means for communicating with the network node based on a communication state of the UE, the communication state of the UE based at least in part on a history of measurements performed on the one or more signals received over the time period.

In another configuration, the example apparatus 1304 also includes means for receiving a network type indicator associated with a mobility condition while communicating with the network node, wherein the UE measures the one or more communications over the time period based on the network type indicator being associated with the mobility condition.

In another configuration, the example apparatus 1304 also includes means for skipping determining the communication state for a network indicating a second network type indicator that is not associated with the mobility condition.

In another configuration, the example apparatus 1304 also includes means for applying a machine learning algorithm to the history of the measurements to detect the communication state of the UE.

In another configuration, the example apparatus 1304 also includes means for applying a first instance of a machine learning algorithm to detect a first communication state of the UE, the first communication state indicating that the network node is associated with an HST cell or associated with a non-HST cell. The example apparatus 1304 also includes means for applying a second instance of the machine learning algorithm to detect a second communication state of the UE when the first communication state indicates that the network node is associated with the HST cell, the second communication state indicating that the UE is in a moving state or a stationary state.

In another configuration, the example apparatus 1304 also includes means for performing a first handover procedure when the communication state is a first communication state. The example apparatus 1304 also includes means for performing a second handover procedure when the communication state is a second communication state, the first handover procedure being a different handover type than the second handover procedure, the first communication state being a different state than the second communication state.

In another configuration, the example apparatus 1304 also includes means for performing a first channel estimation procedure when the communication state is a first communication state. The example apparatus 1304 also includes means for performing a second channel estimation procedure when the communication state is a second communication state, the first channel estimation procedure being a different channel estimation type than the second channel estimation procedure, the first communication state being a different state than the second communication state.

The means may be the communication state determination component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

Aspects disclosed herein facilitate determining or predicting a communication state of a UE based on, for example, measurements performed at the UE. The communication state of the UE, such as an HST state or a non-HST state, may be associated with a mobility state, such as stationary or moving. In some examples, the communication state of the UE may be associated with ambient conditions or behavior of the UE, such as whether the UE is located in an elevator. In some examples, the UE may communicate with a network node based on the communication state.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: establishing a connection with a network node; measuring one or more signals received from the network node over a time period; and communicating with the network node based on a communication state of the UE, the communication state of the UE based at least in part on a history of measurements performed on the one or more signals received over the time period.

Aspect 2 is the method of aspect 1, further including that the communication state of the UE is associated with a mobility state of the UE, the method further including: receiving a network type indicator associated with a mobility condition while communicating with the network node, wherein the UE measures the one or more signals over the time period based on the network type indicator being associated with the mobility condition.

Aspect 3 is the method of any of aspects 1 and 2, further including: skipping determining the communication state for a network indicating a second network type indicator that is not associated with the mobility condition.

Aspect 4 is the method of any of aspects 1 to 3, further including that the network type indicator indicates that the network node is associated with an HST cell.

Aspect 5 is the method of any of aspects 1 to 4, further including that the communication state indicates that the UE is in a moving state or a stationary state with the HST cell and that the UE is located in the HST.

Aspect 6 is the method of any of aspects 1 to 5, further including that the communication state indicates that the UE is in a moving state or a stationary state with the HST cell and that the UE is not located in the HST.

Aspect 7 is the method of any of aspects 1 and 2, further including that the network type indicator indicates that the network node is associated with a non-HST cell.

Aspect 8 is the method of any of aspects 1 to 7, further including that the measurements include at least one of: an RSRP, a frequency error, and a time advance associated with an NTA.

Aspect 9 is the method of any of aspects 1 to 8, further including that the communication state is further based on a rate of PCI change.

Aspect 10 is the method of any of aspects 1 to 9, further including: applying a machine learning algorithm to the history of the measurements to detect the communication state of the UE.

Aspect 11 is the method of any of aspects 1 to 10, further including that the machine learning algorithm includes an LSTM architecture.

Aspect 12 is the method of aspect 1, further including that the communication state indicates is associated with a location within an elevator.

Aspect 13 is the method of aspect 1, further including that the communication state is associated with an ambient condition of the UE.

Aspect 14 is the method of any of aspects 1 to 13, further including: performing a first handover procedure when the communication state is a first communication state, or performing a second handover procedure when the communication state is a second communication state, the first handover procedure being a different handover type than the second handover procedure, the first communication state being a different state than the second communication state.

Aspect 15 is the method of any of aspects 1 to 14, further including: performing a first channel estimation procedure when the communication state is a first communication state, or performing a second channel estimation procedure when the communication state is a second communication state, the first channel estimation procedure being a different channel estimation type than the second channel estimation procedure, the first communication state being a different state than the second communication state.

Aspect 16 is the method of any of aspects 1 to 15, further including: performing a first control channel decoding procedure when the communication state is a first communication state, or performing a second control channel decoding procedure when the communication state is a second communication state, the first control channel decoding procedure being a different control channel decoding type than the second control channel decoding procedure, the first communication state being a different state than the second communication state.

Aspect 17 is an apparatus for wireless communication at a UE including at least one processor coupled to a memory and configured to implement any of aspects 1 to 16.

In aspect 18, the apparatus of aspect 17 further includes at least one antenna coupled to the at least one processor.

In aspect 19, the apparatus of aspect 17 or 18 further includes a transceiver coupled to the at least one processor.

Aspect 20 is an apparatus for wireless communication including means for implementing any of aspects 1 to 16.

In aspect 21, the apparatus of aspect 20 further includes at least one antenna coupled to the means to perform the method of any of aspects 1 to 16.

In aspect 22, the apparatus of aspect 20 or 21 further includes a transceiver coupled to the means to perform the method of any of aspects 1 to 16.

Aspect 23 is a non-transitory computer-readable storage medium storing computer executable code, where the code, when executed, causes a processor to implement any of aspects 1 to 16.

What is claimed is:

1. An apparatus for wireless communication at a user equipment (UE), comprising:
a memory; and
at least one processor coupled to the memory and, based at least in part on information stored in the memory, the at least one processor is configured to:
establish a connection with a network node;
measure one or more signals received from the network node over a time period; and
communicate with the network node based on a communication state of the UE, the communication state of the UE based at least in part on a history of measurements performed on the one or more signals received over the time period.

2. The apparatus of claim 1, wherein the communication state of the UE is associated with a mobility state of the UE, the at least one processor further configured to:
receive a network type indicator associated with a mobility condition while communicating with the network node, wherein the UE measures the one or more signals over the time period based on the network type indicator being associated with the mobility condition.

3. The apparatus of claim 2, wherein the at least one processor is further configured to:
skip determining the communication state for a network indicating a second network type indicator that is not associated with the mobility condition.

4. The apparatus of claim 2, wherein the network type indicator indicates that the network node is associated with a high-speed train (HST) cell.

5. The apparatus of claim 4, wherein the communication state indicates that the UE is in a moving state or a stationary state with the HST cell and that the UE is located in an HST.

6. The apparatus of claim 4, wherein the communication state indicates that the UE is in a moving state or a stationary state with the HST cell and that the UE is not located in an HST.

7. The apparatus of claim 2, wherein the network type indicator indicates that the network node is associated with a non-high-speed train (non-HST) cell.

8. The apparatus of claim 1, wherein the measurements include at least one of:
a Reference Signal Received Power (RSRP),
a frequency error, and
a time advance associated with a Network Time Advance (NTA).

9. The apparatus of claim 8, wherein the communication state is further based on a rate of Physical Cell Identity (PCI) change.

10. The apparatus of claim 1, wherein the at least one processor is further configured to:
apply a machine learning algorithm to the history of the measurements to detect the communication state of the UE.

11. The apparatus of claim 10, wherein the machine learning algorithm includes a long short-term memory (LSTM) architecture.

12. The apparatus of claim 1, wherein the communication state indicates is associated with a location within an elevator.

13. The apparatus of claim 1, wherein the communication state is associated with an ambient condition of the UE.

14. The apparatus of claim 1, wherein the at least one processor is further configured to:
perform a first handover procedure when the communication state is a first communication state, or
perform a second handover procedure when the communication state is a second communication state, the first handover procedure being a different handover type than the second handover procedure, the first communication state being a different state than the second communication state.

15. The apparatus of claim 1, wherein the at least one processor is further configured to:
perform a first channel estimation procedure when the communication state is a first communication state, or
perform a second channel estimation procedure when the communication state is a second communication state, the first channel estimation procedure being a different channel estimation type than the second channel estimation procedure, the first communication state being a different state than the second communication state.

16. The apparatus of claim 1, wherein the at least one processor is further configured to:
perform a first control channel decoding procedure when the communication state is a first communication state, or
perform a second control channel decoding procedure when the communication state is a second communication state, the first control channel decoding procedure being a different control channel decoding type than the second control channel decoding procedure, the first communication state being a different state than the second communication state.

17. The apparatus of claim 1, further comprising a transceiver coupled to the at least one processor.

18. A method of wireless communication at a user equipment (UE), comprising:
establishing a connection with a network node;
measuring one or more signals received from the network node over a time period; and
communicating with the network node based on a communication state of the UE, the communication state of the UE based at least in part on a history of measurements performed on the one or more signals received over the time period.

19. The method of claim 18, wherein the communication state of the UE is associated with a mobility state of the UE, the method further comprising:
receiving a network type indicator associated with a mobility condition while communicating with the network node, wherein the UE measures the one or more signals over the time period based on the network type indicator being associated with the mobility condition.

20. The method of claim 19, further comprising:
skipping determining the communication state for a network indicating a second network type indicator that is not associated with the mobility condition.

21. The method of claim 19, wherein the network type indicator indicates that the network node is associated with a high-speed train (HST) cell.

22. The method of claim 21, wherein the communication state indicates that the UE is in a moving state or a stationary state with the HST cell and that the UE is located in an HST.

23. The method of claim 21, wherein the communication state indicates that the UE is in a moving state or a stationary state with the HST cell and that the UE is not located in an HST.

24. The method of claim 19, wherein the network type indicator indicates that the network node is associated with a non-high-speed train (non-HST) cell.

25. The method of claim 18, wherein the measurements include at least one of:
a Reference Signal Received Power (RSRP),
a frequency error, and
a time advance associated with a Network Time Advance (NTA).

26. The method of claim 18, further comprising:
applying a machine learning algorithm to the history of the measurements to detect the communication state of the UE.

27. The method of claim 18, further comprising:
performing a first handover procedure when the communication state is a first communication state, or
performing a second handover procedure when the communication state is a second communication state, the first handover procedure being a different handover type than the second handover procedure, the first communication state being a different state than the second communication state.

28. The method of claim 18, further comprising:
performing a first channel estimation procedure when the communication state is a first communication state, or
performing a second channel estimation procedure when the communication state is a second communication state, the first channel estimation procedure being a different channel estimation type than the second channel estimation procedure, the first communication state being a different state than the second communication state.

29. The method of claim 18, further comprising:
performing a first control channel decoding procedure when the communication state is a first communication state, or
performing a second control channel decoding procedure when the communication state is a second communication state, the first control channel decoding procedure being a different control channel decoding type than the second control channel decoding procedure, the first communication state being a different state than the second communication state.

30. An apparatus for wireless communication at a user equipment (UE), comprising:
means for establishing a connection with a network node;
means for measuring one or more signals received from the network node over a time period; and
means for communicating with the network node based on a communication state of the UE, the communication state of the UE based at least in part on a history of measurements performed on the one or more signals received over the time period.
